(19) United States
(12) Patent Application Publication
(10) Pub. No.: US 2014/0052605 A1
(43) Pub. Date: Feb. 20, 2014

(54) CONDITIONALLY PERMITTING ACCESS OF TRACKED GEOSPATIAL LOCATION DATA OF A VEHICLE OF A BORROWER BY A LENDING INSTITUTION

(71) Applicants: Tom Beerle, Burlingame, CA (US); Brian Boling, Knoxville, TN (US); Bradley S. Jarvis, Newport Beach, CA (US)

(72) Inventors: Tom Beerle, Burlingame, CA (US); Brian Boling, Knoxville, TN (US); Bradley S. Jarvis, Newport Beach, CA (US)

(73) Assignee: SPIREON, INC., Knoxville, TN (US)

(21) Appl. No.: 13/584,848

(22) Filed: Aug. 14, 2012

(51) Int. Cl. G06Q 40/02

(52) U.S. Cl. 705/38

(57) ABSTRACT

A method includes receiving, at a tracking server, geospatial location data of a vehicle at various points in time from a transmitter installed in the vehicle. The vehicle is associated with a borrower in a loan agreement or a lease agreement with a lending institution. The method also includes permitting a financial entity server associated with the lending institution access to the geospatial location data at the tracking server upon the vehicle exceeding one or more threshold parameter(s) related to the geospatial location data stored thereat and/or the borrower exceeding a threshold parameter related to the loan agreement or the lease agreement stored at the financial entity server.

### FIELD OF TECHNOLOGY

This disclosure relates generally to vehicular tracking and, more particularly, to a method, an apparatus and/or a system of conditionally permitting access of tracked geospatial location data of a vehicle of a borrower by a lending institution.

### BACKGROUND

A vehicular purchase or a non-vehicular purchase (e.g., an electronic item such as a television, a house) may be financed wholly or in part by a lending institution (e.g., a bank, a credit union). For a number of reasons, the lending institution may seek to identify high risk behavior on part of a borrower in order to take preventive action to protect the value of the vehicular purchase or the non-vehicular purchase. One such way to identify high risk behavior may be to know the location of a vehicle of the borrower at a point in time or across multiple points in time. Knowing the location of the vehicle may include enable repossession of a borrowed vehicle or the non-vehicular purchase due to delinquent payments by the borrower. However, a policy (e.g., a governmental policy, a policy mutually agreed to by all parties) may dictate that the information sought by the lending institution be made available to the lending institution solely after a pre-defined conditional event has occurred, thereby rendering the process of acquiring the requisite information cumbersome.

### SUMMARY

Disclosed are a method, an apparatus and/or a system of conditionally permitting access of tracked geospatial location data of a vehicle of a borrower by a lending institution.

In one aspect, a method includes receiving, at a tracking server, geospatial location data of a vehicle at various points in time from a transmitter installed in the vehicle. The vehicle is associated with a borrower in a loan agreement or a lease agreement with a lending institution. The method also includes permitting a financial entity server associated with the lending institution access to the geospatial location data at the tracking server upon the vehicle exceeding one or more threshold parameter(s) related to the geospatial location data stored thereat and/or the borrower exceeding a threshold parameter related to the loan agreement or the lease agreement stored at the financial entity server.

In another aspect, a method includes acquiring, through a data collection device including a processor communicatively coupled to a memory, geospatial location data of a vehicle at various points in time. The vehicle is associated with a borrower in a loan agreement or a lease agreement with a lending institution. The method also includes transmitting the geospatial location data to a collection server upon the vehicle exceeding one or more threshold parameter(s) related to the geospatial location data stored at the data collection device and/or the borrower exceeding a threshold parameter related to the loan agreement or the lease agreement stored at a financial entity server associated with the lending institution.

Further, the method includes enabling, through the collection server, access to the geospatial location data by the financial entity server associated with the lending institution.

In yet another aspect, a system includes a vehicle including a transmitter installed therein to transmit geospatial location thereof at various points in time. The vehicle is associated with a borrower in a loan agreement or a lease agreement with a lending institution. The system also includes a tracking server to receive the geospatial location data of the vehicle and to permit a financial entity server associated with the lending institution access to the geospatial location data upon the vehicle exceeding one or more threshold parameter(s) related to the geospatial location data stored thereat and/or the borrower exceeding a threshold parameter related to the loan agreement or the lease agreement stored at the financial entity server.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a vehicle configured to transmit a geospatial location data thereof, according to one or more embodiments.

FIG. 2 is a schematic view of a tracking server of FIG. 1.

FIG. 3 is a schematic view of a financial entity server of FIG. 1.

FIG. 4 is a schematic view of a data collection device of FIG. 1 configured to transmit data to a collection server based on threshold parameters being exceeded.

FIG. 5 is process flow diagram detailing the operations involved in a method of permitting access to geospatial location data of a vehicle associated with a borrower in a loan agreement/lease agreement with a lending institution, according to one or more embodiments.

FIG. 6 is a process flow diagram detailing the operations involved in another method of permitting access to geospatial location data of a vehicle associated with a borrower in a loan agreement/lease agreement with a lending institution, according to one or more embodiments.

Other features of the present embodiments will be apparent from the accompanying drawings and from the detailed description that follows.

### DETAILED DESCRIPTION

Example embodiments, as described below, may be used to provide a method, a system and/or an apparatus of conditionally permitting access of tracked geospatial location data of a vehicle of a borrower by a lending institution. Although the present embodiments have been described with reference to specific example embodiments, it will be evident that various modifications and changes may be made to these embodiments without departing from the broader spirit and scope of the various embodiments.

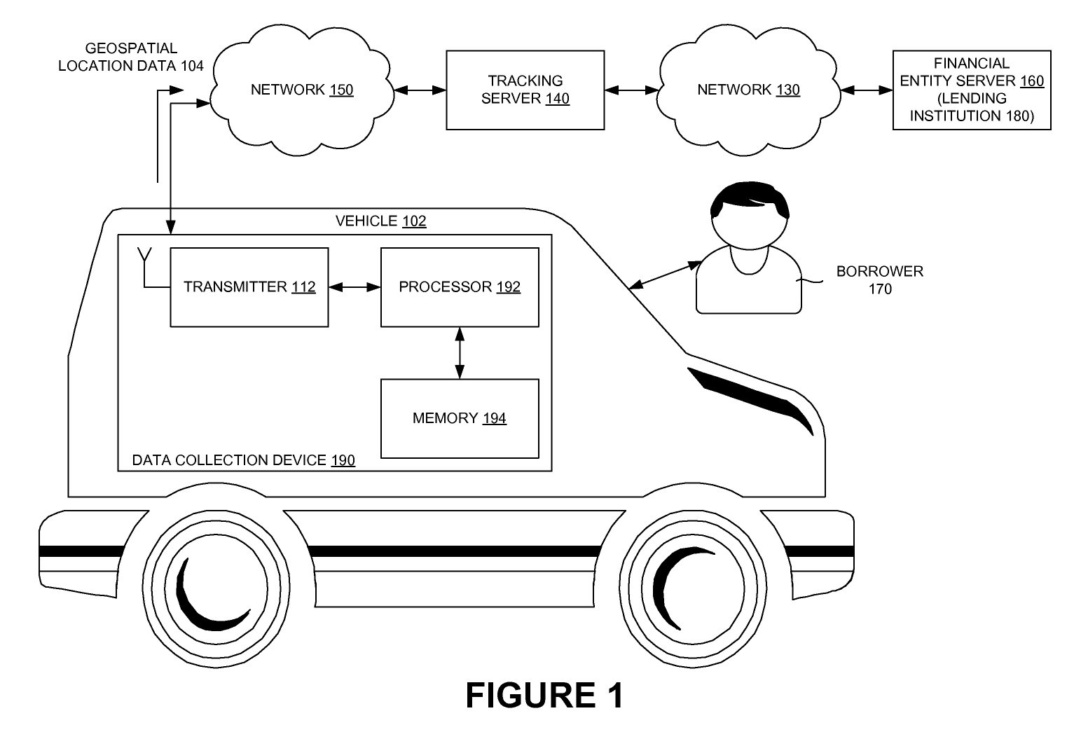

FIG. 1 shows a vehicle 102 configured to transmit a geospatial location data 104 thereof, according to one or more embodiments. In one or more embodiments, vehicle 102 may include a transmitter 112 (e.g., part of a transceiver) mounted therein to transmit geospatial location data 104 to a tracking server 140 (e.g., an entity providing tracking services, an Original Equipment Manufacturer (OEM)). In one or more embodiments, vehicle 102 may be obtained by a borrower 170 based on a loan/lease agreement between borrower 170 and a lending institution 180 (e.g., a bank, a credit union, an automobile dealer, a car rental agency). In a preferred embodiment, tracking server 140 may be maintained by a third-party (e.g., provider of equipment including transmitter 112 and/or tracking services associated therewith) relative to lending institution 180.

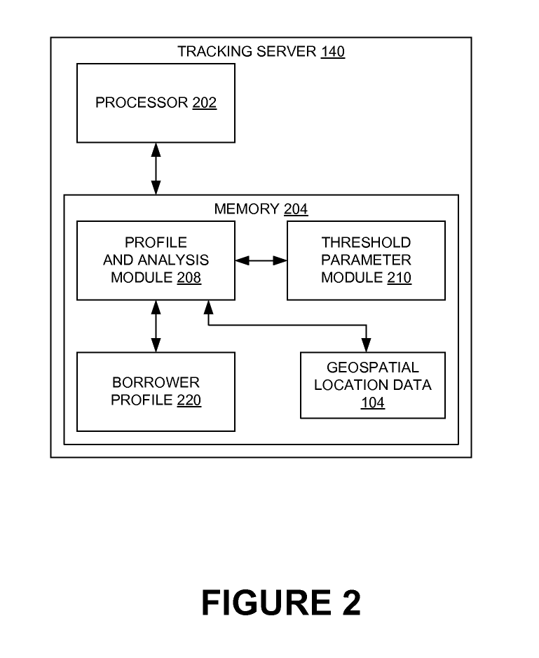

In one or more embodiments, lending institution 180 may be entitled to confiscate, seize and/or sell vehicle 102 to discharge the debt associated with a security interest in vehicle 102. In one or more embodiments, tracking server 140 may be configured to receive geospatial location data 104 of vehicle 102 at various points in time and store the aforementioned data in a memory thereof (see FIG. 2). For example, transmitter 112 mounted on vehicle 102 may transmit geospatial location data 104 thereof on a periodic basis (e.g., once every hour, once every day). In another example, transmitter 112 may transmit geospatial location data 104 of vehicle 102 whenever a condition (e.g., vehicle 102 transitioning into a new geographical location different from a default/current geographical location; geographical locations may be delimited by geospatial coordinates, vehicle 102 staying put at the same geographical location beyond a threshold time period) is met.

In one or more embodiments, transmitter 112 may be part of a data collection device 190 installed on vehicle 102. In one or more embodiments, data collection device 190 may be a Global Position System (GPS) enabled device. GPS technology is well known to one of ordinary skill in the art and, therefore, discussion associated with acquiring location information, signal reception from orbiting satellites et al. is skipped for the sake of brevity and convenience. In one or more embodiments, data collection device 190 may include a processor 192 communicatively coupled to a memory 194. Here, processor 192 may be configured to address storage locations in memory 194 (e.g., a volatile memory), and may be configured to execute instructions (e.g., stored in memory 194) associated with the procuring of geospatial location data 104 and the transmission thereof, in conjunction with transmitter 112. Transmitter 112 is shown as being coupled to processor 192 in FIG. 1.

In one or more embodiments, data collection device 190 may be coupled to tracking server 140 through a network 150. In one or more embodiments, network 150 may be a mobile network or a Wide Area Network (WAN). FIG. 2 shows tracking server 140, according to one or more embodiments. In one or more embodiments, tracking server 140 may include a processor 202 communicatively coupled to a memory 204 (e.g., a volatile memory, non-volatile memory). Again, here, processor 202 may be configured to address storage locations in memory 204. In one or more embodiments, memory 204 may be configured to store geospatial location data 104 associated with vehicle 102. In one or more embodiments, memory 204 may also have a profiling and analysis module 208 stored therein. Profiling and analysis module 208 may include instructions executable through processor 202. The aforementioned instructions may be associated with processes such as analyzing geospatial location data 104 to profile borrower 170 and building a risk profile thereof.

Moreover, memory 204 may also store a threshold parameter module 210 therein. Threshold parameter module 210 may also include instructions executable through processor 202. Here, the instructions may be related to verifying whether vehicle 104 crosses into a new geographical area, whether vehicle 104 is in the same geographical area for a time exceeding a threshold, whether data collection device 190 is tampered with etc. For example, tampering of data collection device 190 by borrower 170 may trigger an appropriate message communication from data collection device 190 to tracking server 140. It is obvious that tracking server 140 may merely be a forwarding terminal, and that the aforementioned profiling and analysis may be performed on a master server distinct from the forwarding terminal. FIGS. 1-2 serve to present tracking server 140 as performing the profiling and analysis merely as an example. Alternatively, tracking server 140 may be a network of individual servers configured to perform one or more functions such as borrower profiling and/or analysis as a collective unit.

Several scenarios may serve to provide data for the profiling of borrower 170. For example, when vehicle 102 associated with borrower 170 does not appear at a specified location (e.g., work location) for a time exceeding a threshold, tracking server 140 may profile borrower 170 based on the aforementioned risky behavior exhibited through the reception of geospatial location data 104 of vehicle 102. In another example, when vehicle 102 associated with borrower 170 leaves a geographical region representing a possible place of residence thereof and/or a possible place of work thereof for a time exceeding a threshold (e.g., 15 days) and/or the new geographical location corresponding to geospatial location data 104 received at tracking server 140 is separated from the possible place of residence and/or the possible place of work by a distance exceeding a threshold, tracking server 140 may, again, profile borrower 170 as risky. In yet another example, vehicle 102 may be in an impound lot for a time exceeding a threshold, which may trigger tracking server 140 to profile borrower 170 appropriately. Other scenarios exhibiting eccentric usage pattern(s) of vehicle 102 are within the scope of the exemplary embodiments.

It is obvious that the collection of geospatial location data 104 of vehicle 102 on a regular basis may aid in better profiling of borrower 170 because borrower 170 may exhibit “patterns.” In one or more embodiments, tracking server 140 may generate borrower profile 220 of borrower 170 based on the pattern of behavior exhibited, and may transmit geospatial location data 104 and/or the aforementioned borrower profile 220 to a financial entity server 160 directly associated with lending institution 180. Alternately, tracking server 140 may be interpreted as a network of servers including financial entity server 160. In one or more embodiments, borrower profile 220 may be updated with new geospatial location data 104 received from vehicle 102. In one or more embodiments, financial entity server 160 may be configured to generate one or more alerts regarding a need to confiscate vehicle 102 based on the received geospatial location data 104 and/or the risk pattern determined through tracking server 140. The profiling of borrower 170 may occur at tracking server 140 regardless of whether borrower 170 discharges duties associated with the loan payments on a regular basis or not. The threshold tolerance limit of eccentricity in usage patterns of vehicle 102 may be higher for a borrower 170 diligently discharging loan payment duties as compared to a borrower 170 defaulting on a regular basis.

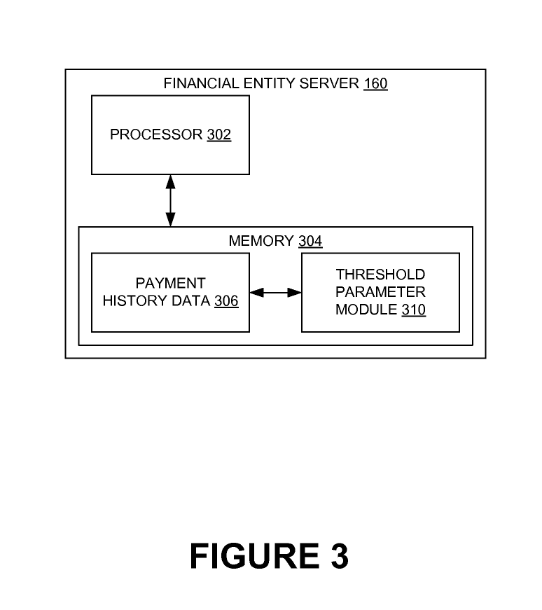

In one or more embodiments, financial entity server 160 may also include a processor 302 communicatively coupled to a memory 304 (as shown in FIG. 3), where memory 304 may have payment history data 306 of borrower 170 stored therein. In one or more embodiments, payment history data 306 may be made available to tracking server 140 either all the time or on a conditional basis. However, in one or more embodiments, a policy (e.g., a governmental policy, a policy mutually agreed to by all parties) may dictate that geospatial location data 104 be made available to tracking server 140 solely after one or more threshold parameter(s) related to geospatial location data 104 and/or a threshold parameter related to payment default by borrower 170 (e.g., with lending institution 180) are exceeded.

Examples of exceeding threshold parameters may include vehicle 102 venturing into a number of new geographical areas exceeding a threshold, vehicle 102 being in a new geographical area for a time exceeding a threshold, borrower 170 defaulting on payments for a time exceeding a threshold, borrower 170 violating terms of the loan agreement or the lease agreement with/without defaulting on payments, data collection device 190 being tampered with etc. Other derivable threshold parameters are within the scope of the exemplary embodiments. In one or more embodiments, financial entity server 160 may be coupled to tracking server 140 through a network 130 (e.g., same as network 150, or, a different computer network).

In one or more embodiments, financial entity server 160 may also have threshold parameters thereof stored in memory 304. FIG. 3 shows threshold parameter module 310 of financial entity server 160 stored in memory 304 thereof. Instructions associated with threshold parameter module 310 are configured to be executable through processor 302. An example scenario may involve borrower 170 not defaulting on his loan payments. However, after tracking server 140 determines borrower 170 to have exceeded a threshold level of risk (e.g., based on executing threshold parameter module 210), geospatial location data 104 and/or borrower profile 220 may be available to lending institution 180 through financial entity server 160. Lending institution 180 may, thus, be provided the capability to seize/confiscate vehicle 102 (serving as collateral on behalf of borrower 170) even if borrower 170 is a non-defaulting payer.

Another example scenario may involve tracking server 140 being associated with a collection agency. A long period of non-payment by borrower 170 may exceed a threshold set through threshold parameter module 310 of financial entity server 160. Upon the threshold being exceeded, geospatial location data 104 and/or borrower profile 220 of borrower 170 may be made available to the collection agency through tracking server 140 in order to aid informed decision making therefrom (e.g., to decide whether to use geospatial location data 104/borrower profile 220 in conjunction with the defaulted payments to determine collection amount, to confiscate vehicle 102 et al.).

Examples of payment history data 306 also include status information of borrower 170 with regard to payments on vehicle 102 with lending institution 180. For example, access to geospatial location data 104 and/or borrower profile 220 may be provided to financial entity server 160 merely based on the aforementioned status information (e.g., lending institution 180 may provide borrower status information as a 1 or a 0; the 0 status may trigger the access of geospatial location data 104 and/or borrower profile 220) of borrower 170. The scope of payment history data 306 is, therefore, broader than mere financial payment history.

Further, it is obvious that borrower 170 may be tied directly to vehicle 102 and/or data collection device 190. For example, in certain cases, privacy issues may render lending institution 180 being unable to see the name of a defaulting/threshold exceeding borrower 170. Rather, the status information may be tied to a Vehicle Identification Number (VIN) of vehicle 102 or an identifier of data collection device 190.

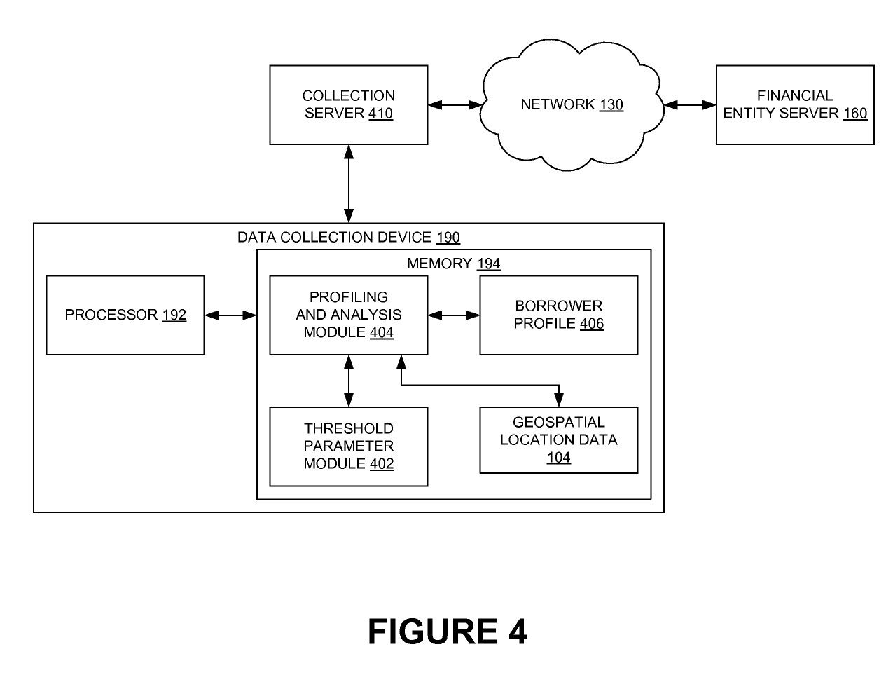

It may not always be required for geospatial location data 104 to be transmitted from vehicle 102 to tracking server 140. FIG. 4 shows data collection device 190 of vehicle 102 being configured to perform analysis of geospatial location data 104 thereat. Here, processor 192 may execute instructions associated with a threshold parameter module 402 and/or a profiling and analysis module 404 stored in memory 194. Upon vehicle 102 (by way of borrower 170) exceeding threshold risk parameters, borrower profile 406 (stored in memory 194) may be configured to be transmitted to collection server 410, which, in turn, may provide access to geospatial location data 104 and/or borrower profile 406 to financial entity server 160. Otherwise, collection server 410 may function analogous to tracking server 140 discussed with regard to FIGS. 1-3.

Although exemplary embodiments have been discussed with regard to a borrowed vehicle 102, concepts involved herein may also apply to a non-vehicular purchase (e.g., a television, a house) financed by lending institution 180. Financial entity server 160 may conditionally gain access to geospatial location data of borrower 170 based on one or more threshold parameters (e.g., related to geospatial location data, related to the loan agreement or the lease agreement) being exceeded.

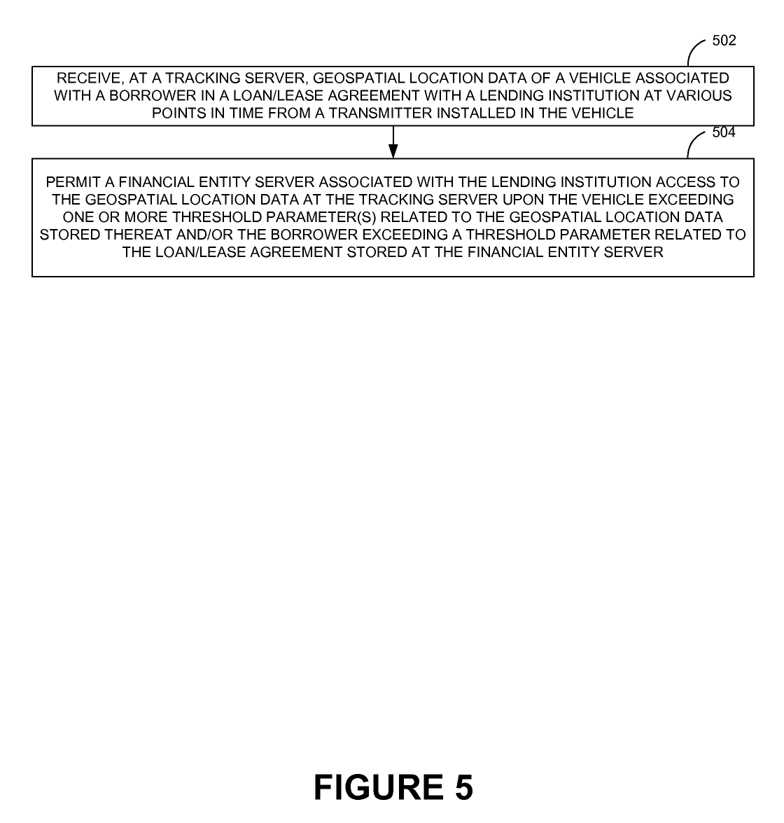

FIG. 5 shows a process flow diagram detailing the operations involved in a method of permitting access to geospatial location data 104 of vehicle 102 associated with borrower 170 in a loan agreement/lease agreement with lending institution 180, according to one or more embodiments. In one or more embodiments, operation 502 may involve receiving, at tracking server 140, geospatial location data 104 of vehicle 102 at various points in time from transmitter 112 installed in vehicle 102.

In one or more embodiments, operation 504 may involve permitting financial entity server 160 associated with lending institution 180 access to geospatial location data 104 at tracking server 140 upon vehicle 102 exceeding one or more threshold parameter(s) related to geospatial location data 104 stored thereat and/or borrower 170 exceeding a threshold parameter related to the loan agreement or the lease agreement stored at financial entity server 160.

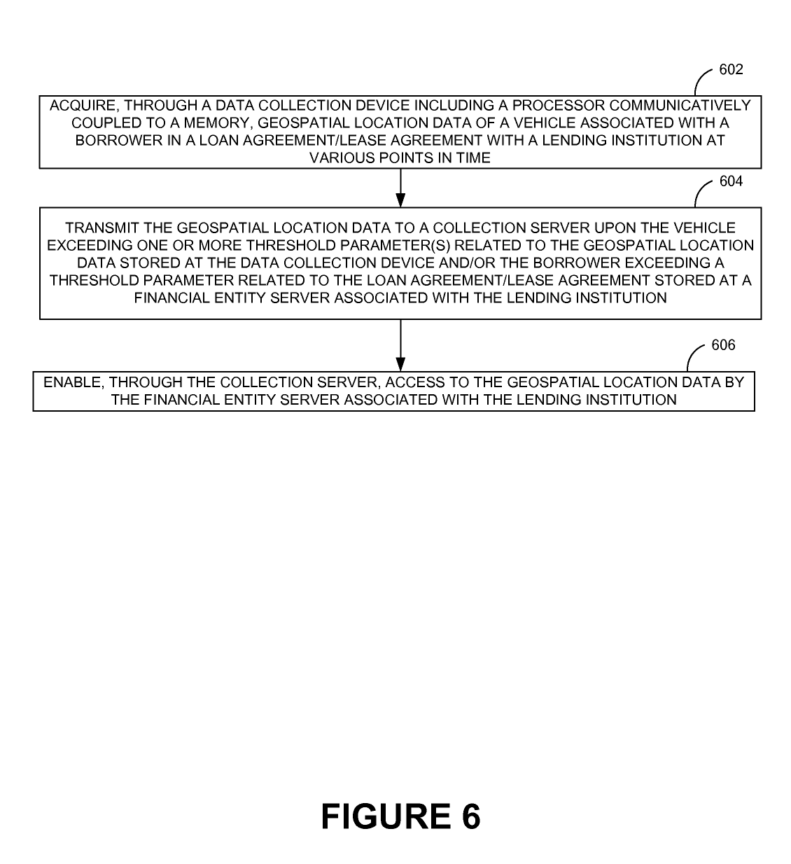

FIG. 6 shows a process flow diagram detailing the operations involved in another method of permitting access to geospatial location data 104 of vehicle 102 associated with borrower 170 in a loan agreement/lease agreement with lending institution 180, according to one or more embodiments. In one or more embodiments, operation 602 may involve acquiring, through data collection device 190 including processor 192 communicatively coupled to memory 194, geospatial location data 104 of vehicle 102 at various points in time.

In one or more embodiments, operation 604 may involve transmitting geospatial location data 104 to collection server 410 upon vehicle 102 exceeding one or more threshold parameter(s) related to geospatial location data 104 stored at data collection device 190 and/or borrower 170 exceeding a threshold parameter related to the loan agreement or the lease agreement stored at a financial entity server 160 associated with lending institution 180.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium). For example, the various electrical structure and methods may be embodied using transistors, logic gates, and electrical circuits (e.g., application specific integrated (ASIC) circuitry and/or Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer device). Accordingly, the specification and drawings are to be regarded in an illustrative rather than a restrictive sense.

What is claimed is:

1. A method comprising:
receiving, at a tracking server, geospatial location data of a vehicle at various points in time from a transmitter installed in the vehicle, the vehicle being associated with a borrower in one of a loan agreement and a lease agreement with a lending institution; and
permitting a financial entity server associated with the lending institution access to the geospatial location data at the tracking server upon at least one of: the vehicle exceeding at least one threshold parameter related to the geospatial location data stored thereat and the borrower exceeding a threshold parameter related to the one of the loan agreement and the lease agreement stored at the financial entity server.

2. The method of claim 1, further comprising risk profiling, at the tracking server, the borrower based on the received geospatial location data.

3. The method of claim 1, further comprising receiving, through the tracking server, an alert relating to confiscating the vehicle based on the access of the geospatial location data by the financial entity server.

4. The method of claim 1, wherein at least one of:
the tracking server and the financial entity server are configured to communicate through a computer network, and
the threshold parameter related to the one of the loan agreement and the lease agreement is a threshold parameter of default associated with payments related to the one of the loan agreement and the lease agreement.

5. The method of claim 2, wherein the risk profiling at the tracking server incorporates tampering with a data collection device including the transmitter installed in the vehicle.

6. The method of claim 2, wherein the risk profiling at the tracking server further comprises forwarding the geospatial location data of the vehicle to another server for analysis thereat.

7. The method of claim 1, comprising receiving the geospatial location data of the vehicle at the tracking server on a periodic basis.

8. A method comprising:
acquiring, through a data collection device including a processor communicatively coupled to a memory, geospatial location data of a vehicle at various points in time, the vehicle being associated with a borrower in one of a loan agreement and a lease agreement with a lending institution;
transmitting the geospatial location data to a collection server upon at least one of:
the vehicle exceeding at least one threshold parameter related to the geospatial location data stored at the data collection device and the borrower exceeding a threshold parameter related to the one of the loan agreement and the lease agreement stored at a financial entity server associated with the lending institution; and
enabling, through the collection server, access to the geospatial location data by the financial entity server associated with the lending institution.

9. The method of claim 8, further comprising profiling, at the data collection device, the borrower based on the acquired geospatial location data.

10. The method of claim 8, further comprising receiving, through the collection server, an alert relating to confiscating the vehicle based on the access of the geospatial location data by the financial entity server.

11. The method of claim 8, wherein at least one of:
the collection server and the financial entity server are configured to communicate through a computer network, and
the threshold parameter related to the one of the loan agreement and the lease agreement is a threshold parameter of default associated with payments related to the one of the loan agreement and the lease agreement.

12. The method of claim 9, wherein the profiling at the data collection device incorporates tampering with the data collection device.

13. The method of claim 9, wherein the profiling at the data collection device further comprises forwarding the geospatial location data of the vehicle to another server for analysis thereat.

14. The method of claim 8, comprising acquiring the geospatial location data of the vehicle at the data collection device on a periodic basis.

15. A system comprising:
a vehicle including a transmitter installed therein to transmit geospatial location thereof at various points in time, the vehicle being associated with a borrower in one of a loan agreement and a lease agreement with a lending institution; and
a tracking server to:
receive the geospatial location data of the vehicle, and
permit a financial entity server associated with the lending institution access to the geospatial location data upon at least one of: the vehicle exceeding at least one threshold parameter related to the geospatial location data stored thereat and the borrower exceeding a threshold parameter related to the one of the loan agreement and the lease agreement stored at the financial entity server.

16. The system of claim 15, wherein the tracking server is further configured to profile the borrower based on the received geospatial location data.

17. The system of claim 15, wherein the tracking server is further configured to receive an alert relating to confiscating the vehicle based on the access of the geospatial location data by the financial entity server.

18. The system of claim 15, wherein at least one of:
the tracking server and the financial entity server are communicatively coupled through a computer network, and
the threshold parameter related to the one of the loan agreement and the lease agreement is a threshold parameter of default associated with payments related to the one of the loan agreement and the lease agreement.

19. The system of claim 16, wherein the tracking server incorporates tampering with a data collection device including the transmitter installed in the vehicle by the borrower in the profiling of the borrower.

20. The system of claim 16, wherein the tracking server is further configured to forward the geospatial location data of the vehicle to another server for analysis thereat in order to profile the borrower.
